(19) United States
(12) Patent Application Publication
(10) Pub. No.: US 2024/0272278 A1
(43) Pub. Date: Aug. 15, 2024

(54) POSE DETECTION USING MULTI-CHIRP FMCW RADAR

(71) Applicant: Microsoft Technology Licensing, LLC, Redmond, WA (US)

(72) Inventors: Jouya JADIDIAN, Los Gatos, CA (US); Tara BOROUSHAKI, Cambridge, MA (US); Jorge Mario SALAZAR RÍOS, Caldas (CO)

(21) Appl. No.: 18/169,128

(22) Filed: Feb. 14, 2023

(51) Int. Cl. G01S 7/41; G01S 13/34; G01S 13/86; G06F 3/01

(52) U.S. Cl. CPC G01S 7/411; G01S 13/347; G01S 13/86; G01S 13/867; G06F 3/011

(57) ABSTRACT

A system for facilitating pose detection using multi-chirp FMCW radar is configurable to emit a multi-chirp frequency modulated continuous wave (FMCW) radar signal comprising a high-bandwidth chirp and a low-bandwidth chirp, detect a reflected multi-chirp FMCW radar signal comprising a reflected high-bandwidth chirp and a reflected low-bandwidth chirp, determine a first object pose data using the reflected high-bandwidth chirp, and determine a second object pose data using the reflected low-bandwidth chirp.

### BACKGROUND

Mixed-reality (MR) systems, including virtual-reality and augmented-reality systems, have received significant attention because of their ability to create unique experiences for their users. For reference, conventional virtual-reality (VR) systems create a completely immersive experience by restricting their users' views to only a virtual environment. This is often achieved, in VR systems, through the use of a head-mounted display (HMD) that completely blocks any view of the real world. As a result, a user is entirely immersed within the virtual environment. In contrast, conventional augmented-reality (AR) systems create an augmented-reality experience by visually presenting virtual objects (via an HMD) that are placed in or that interact with the real world.

As used herein, VR and AR systems are described and referenced interchangeably. Unless stated otherwise, the descriptions herein apply equally to all types of mixed-reality systems, which (as detailed above) includes AR systems, VR reality systems, and/or any other similar system capable of displaying virtual objects.

To facilitate MR experiences, many HMDs include various sensors that are used to track the position of the user. For example, many HMDs include camera sensors that are used to capture imagery of the surrounding environment and/or parts of the user's body (e.g., the user's hands, eyes, etc.). In some instances, HMDs include illumination components to illuminate user environments (or user body parts, such as eyes or hands) for image acquisition. Imagery captured by an HMD may be processed in various ways to obtain information for facilitating an MR experience. Example processing may include depth processing, object segmentation, feature extraction or matching, and/or others. Information acquired based upon the imagery can enable HMDs to map the user's environment, track the position of the user (or the position of the HMD) within the environment, track movement of the user's hands or eyes, as well as perform other functions related to presenting realistic MR experiences.

The subject matter claimed herein is not limited to embodiments that operate only in environments such as those described above. Rather, this background is only provided to illustrate one example technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates example components of an example system that may include or be used to implement one or more disclosed embodiments.

FIG. 2A illustrates a user operating an HMD that includes a radar system emitting a multi-chirp frequency modulated continuous wave (FMCW) radar signal.

FIG. 2B illustrates a conceptual representation of determining pose information based on the reflected high-bandwidth chirp and the reflected low-bandwidth chirp;

FIG. 2C illustrates a conceptual representation of selectively activating an additional tracking system based on the pose information obtained via a radar system of the HMD.

FIGS. 3 and 4 illustrate example flow diagrams depicting acts associated with facilitating pose detection via multi-chirp FMCW radar.

### DETAILED DESCRIPTION

Disclosed embodiments are generally directed to systems, methods, and apparatuses for facilitating pose detection via multi-chirp frequency modulated continuous wave (FMCW) radar.

As noted above, many HMDs include image sensors for capturing sensor data usable to facilitate MR experiences. However, the applicability of image sensors for tracking the poses of various user body parts is limited by occlusion. For instance, HMD-mounted cameras often have difficulty detecting a user's feet, knees, or waist due to occlusions caused by the user's shoulders, arms, etc. Current HMD sensor systems are thus limited in their ability to detect full-body poses of users.

FMCW radar sensors may potentially be implemented on HMDs to facilitate tracking of certain body structures. High bandwidth FMCW radar signals can track objects with high precision (e.g., with centimeter precision) and may therefore be utilized to track feet, knees, hands, and/or other structures in an accurate manner. However, FMCW radar sensors have received limited attention as potential sensors for HMDs in view of regulatory restrictions related to power and bandwidth. For instance, some regulatory bodies restrict FMCW radar power for high bandwidth signals on certain types of devices (including HMDs). As a result, high-bandwidth FMCW radar systems are often limited in detection range (e.g., to one meter or less) on certain types of devices. This can make such FMCW radar signals undesirable for detecting poses of user legs, feet, or other body structures that are typically positioned far from HMDs.

Some regulatory bodies have different radar power restrictions for lower bandwidth FMCW radar signals, allowing them to have higher radar power and thus a greater detection range. Although such low-bandwidth FMCW radar signals might be usable to track body structures that are further from the radar system (e.g., a user's legs or feet for a radar system mounted to an HMD), low-bandwidth FMCW radar signals suffer from a lower distance resolution (e.g., four inches to one foot). This makes low-bandwidth FMCW radar signals undesirable for tracking body structures for which high-resolution tracking is important to MR experiences, such as user hands.

At least some disclosed embodiments are directed to radar systems that utilize multi-chirp FMCW radar signals. For instance, a single radar may utilize different FMCW chirps with different bandwidths for tracking body limbs (and/or other objects). An FMCW signal may include a high-bandwidth chirp and a low-bandwidth chirp, and the high-bandwidth chirp may comprise a lower transmission power than the low-bandwidth chirp (e.g., in compliance with applicable regulations).

Such radar systems may be implemented on HMDs to facilitate tracking of bodily structures. In some instances, an HMD with a multi-chirp FMCW radar system as disclosed herein may track hands with high accuracy utilizing the high-bandwidth component/chirp of the radar signal. The HMD may similarly leverage the low-bandwidth component/chirp of the radar signal to track legs, floors, and/or other objects that are further from the HMD with sufficient accuracy for body tracking applications. Such functionality may be achieved while still complying with applicable regulatory constraints on FMCW radar bandwidth and power.

In some instances, the pose information obtained by the FMCW radar systems of the present disclosure may be utilized in conjunction with other sensors and/or processes. For example, where an HMD includes articulated hand tracking sensors and/or modules, an FMCW radar system of the HMD may be utilized to detect whether any of the user's hands are within (or are approaching) the field of view of the HMD. In response to detecting that either of the user's hands are within (or approaching) the field of view, the HMD may selectively activate its hand tracking sensors and/or modules. Such functionality may achieve significant power savings and/or improved user experiences by allowing systems to refrain from expending power and/or computational resources on hand tracking when the hands are not visible, while still providing a seamless hand tracking user experience by selectively activating hand tracking when appropriate.

Although many of the examples described herein focus, in at least some respects, on radar systems implemented on HMDs, the principles described herein related to multi-chirp FMCW signals may be applied in other contexts (e.g., on autonomous vehicles and/or other types of systems).

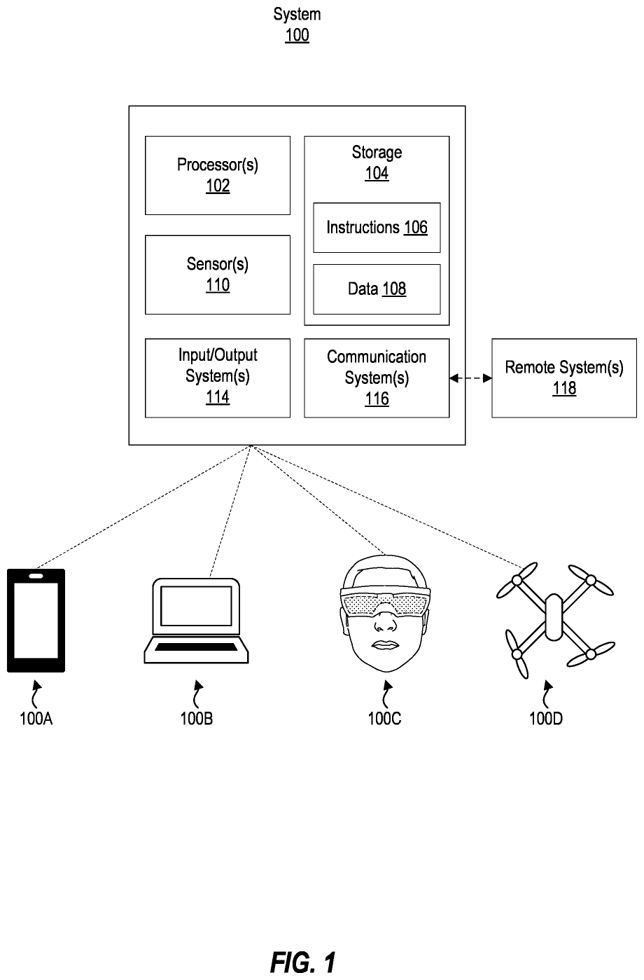

Having just described some of the various high-level features and benefits associated with the disclosed embodiments, attention will now be directed to FIGS. 1 through 4 These Figures illustrate various conceptual representations, architectures, methods, and supporting illustrations related to the disclosed embodiments.

### Example Systems and Components

FIG. 1 illustrates various example components of a system 100 that may be used to implement one or more disclosed embodiments. For example, FIG. 1 illustrates that a system 100 may include processor(s) 102, storage 104, sensor(s) 110, input/output system(s) 114 (I/O system(s) 114), and communication system(s) 116. Although FIG. 1 illustrates a system 100 as including particular components, one will appreciate, in view of the present disclosure, that a system 100 may comprise any number of additional or alternative components.

The processor(s) 102 may comprise one or more sets of electronic circuitries that include any number of logic units, registers, and/or control units to facilitate the execution of computer-readable instructions (e.g., instructions that form a computer program). Such computer-readable instructions may be stored within storage 104. The storage 104 may comprise physical system memory and may be volatile, non-volatile, or some combination thereof. Furthermore, storage 104 may comprise local storage, remote storage (e.g., accessible via communication system(s) 116 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As will be described in more detail, the processor(s) 102 may be configured to execute instructions 106 stored within storage 104 to perform certain actions. The actions may rely at least in part on data 108 stored on storage 104 in a volatile or non-volatile manner.

In some instances, the actions may rely at least in part on communication system(s) 116 for receiving data from remote system(s) 118, which may include, for example, separate systems or computing devices, sensors, and/or others. The communications system(s) 116 may comprise any combination of software or hardware components that are operable to facilitate communication between on-system components/devices and/or with off-system components/devices. For example, the communications system(s) 116 may comprise ports, buses, or other physical connection apparatuses for communicating with other devices/components. Additionally, or alternatively, the communications system(s) 116 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 1 illustrates that a system 100 may comprise or be in communication with sensor(s) 110. Sensor(s) 110 may comprise any device for capturing or measuring data representative of perceivable or detectable phenomenon. By way of non-limiting example, the sensor(s) 110 may comprise one or more radar sensors (as will be described in more detail hereinbelow), image sensors, microphones, thermometers, barometers, magnetometers, accelerometers, gyroscopes, and/or others.

Furthermore, FIG. 1 illustrates that a system 100 may comprise or be in communication with I/O system(s) 114. I/O system(s) 114 may include any type of input or output device such as, by way of non-limiting example, a touch screen, a mouse, a keyboard, a controller, and/or others, without limitation. For example, the I/O system(s) 114 may include a display system that may comprise any number of display panels, optics, laser scanning display assemblies, and/or other components.

FIG. 1 conceptually represents that the components of the system 100 may comprise or utilize various types of devices, such as mobile electronic device 100A (e.g., a smartphone), personal computing device 100B (e.g., a laptop), a mixed-reality head-mounted display 100C (HMD 100C), an aerial vehicle 100D (e.g., a drone), and/or other devices (e.g., self-driving vehicles). A system 100 may take on other forms in accordance with the present disclosure.

### Pose Detection Using Multi-Chirp FMCW Radar

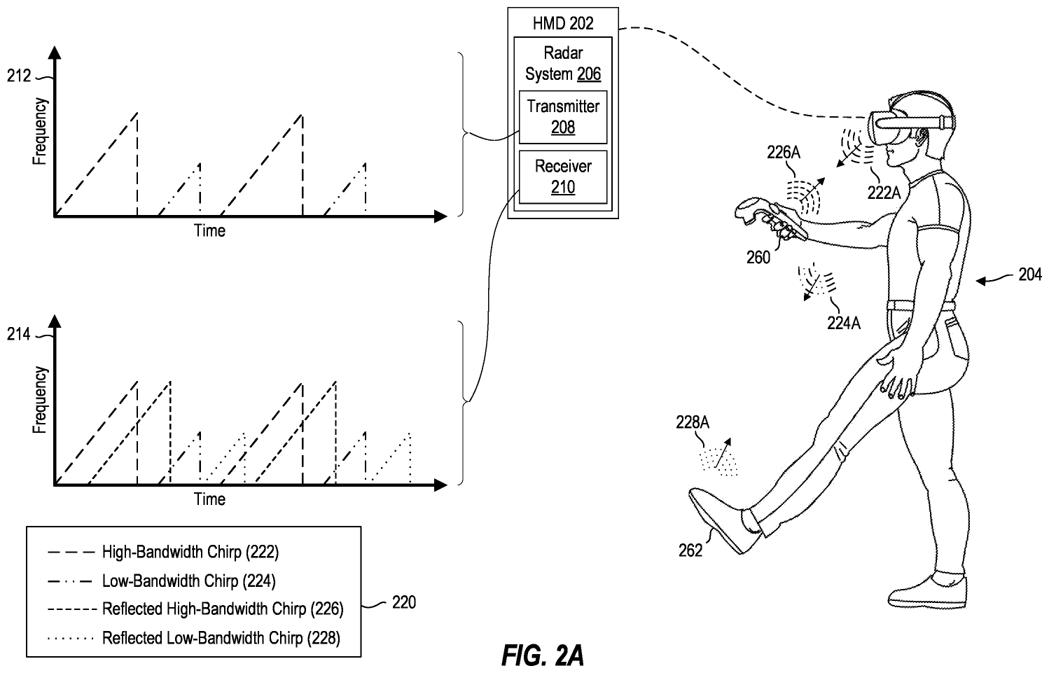

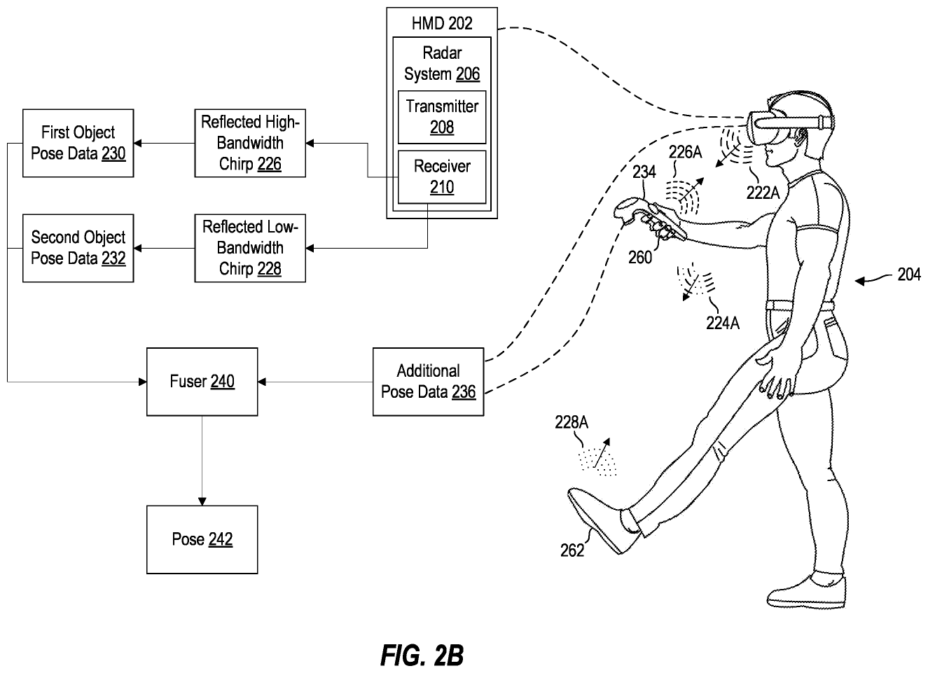

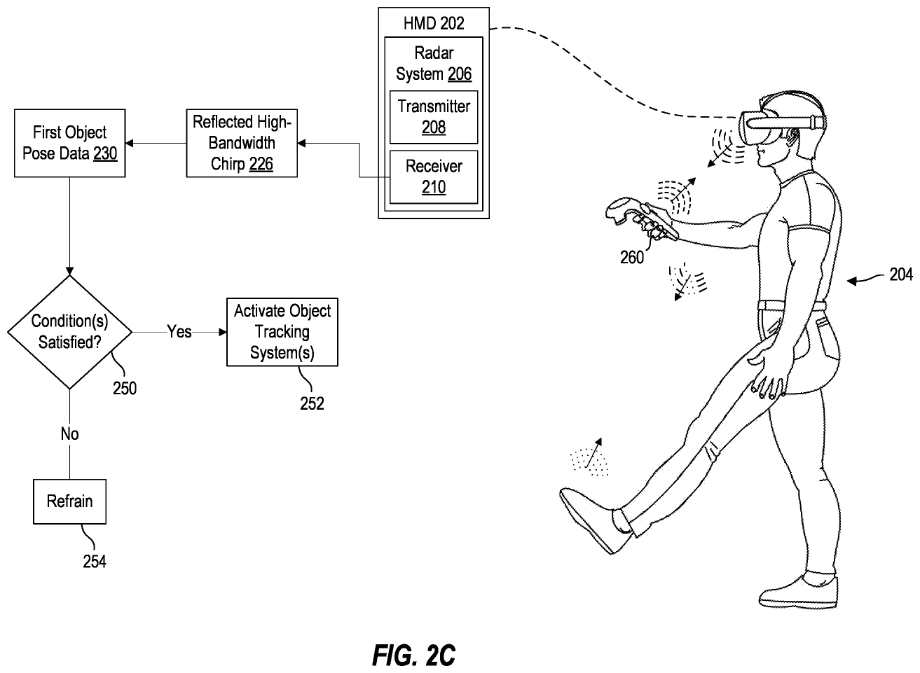

FIG. 2A illustrates a user 204 operating an HMD 202 (e.g., corresponding to system 100) that includes a radar system 206 (e.g., corresponding to sensor(s) 110). FIG. 2A indicates that the radar system 206 includes at least a transmitter 208 configured to emit radar signals and a receiver 210 configured to detect reflected radar signals (e.g., after reflection off of objects within proximity to the transmitter 208).

One will appreciate, in view of the present disclosure, that the HMD 202 may comprise any number of radar systems 206, and a radar system 206 may comprise any number of transmitters 208 and any number of receivers 210. For instance, in one example, the HMD 202 may include a radar system 206 with a first set of radar transmitters 208 and receivers 210 tilted downward (with respect to the horizontal plane of the HMD 202) and a radar system 206 with a second set of radar transmitters 208 and receivers 210 tilted upward (with respect to the horizontal plane of the HMD 202). In some instances, separate radar systems 206 may comprise at least partially overlapping fields of view.

In the example of FIG. 2A, the radar system 206 comprises an FMCW radar system, and the transmitter 208 is configured to emit an FMCW radar signal. Graph 212 of FIG. 2A provides a simplified representation of aspects of multi-chirp FMCW radar signals that the radar system 206 may be configured to emit (e.g., via the transmitter 208). In particular, the multi-chirp FMCW radar signal represented in graph 212 includes a high-bandwidth chirp 222 (represented in FIG. 2A with dashed lines, see legend 220) and a low-bandwidth chirp 224 (represented in FIG. 2A with dash-dot-dot lines, see legend 220). One will appreciate that the particular form of the radar signal depicted in FIG. 2A is provided by way of example only and is not limiting of the principles described herein. Furthermore, a multi-chirp FMCW radar signal may include any number of chirps with different bandwidths, in accordance with the present disclosure.

As shown in FIG. 2A, the high-bandwidth chirp 222 and the low-bandwidth chirp 224 are interleaved to form the multi-chirp FMCW radar signal of graph 212. Although graph 212 illustrates interleaving of single high-bandwidth chirps with single low-bandwidth chirps, any number of high-bandwidth chirps or low-bandwidth chirps may be emitted consecutively. In this regard, a multi-chirp FMCW radar signal may comprise sets of one or more of high-bandwidth chirps that are interleaved with sets of one or more low-bandwidth chirps.

The high-bandwidth chirp 222 comprises a higher bandwidth of frequencies than the low-bandwidth chirp 224 (as indicated in graph 212 by the high-bandwidth chirp 222 extending across a greater frequency space than the low-bandwidth chirp 224). For instance, in one example, the high-bandwidth chirp 222 comprises a bandwidth of about 6.8 GHz, and/or the low-bandwidth chirp 224 comprises a bandwidth of about 3.4 GHz. Other bandwidth configurations are within the scope of the present disclosure, such as, by way of non-limiting example, the high-bandwidth chirp 222 comprising a bandwidth greater than about 7 GHz with the low-bandwidth chirp 224 comprising a bandwidth lesser than about 7 GHz, the high-bandwidth chirp 222 comprising a bandwidth greater than about 6 GHz with the low-bandwidth chirp 224 comprising a bandwidth lesser than about 6 GHz, the high-bandwidth chirp 222 comprising a bandwidth greater than about 5 GHz with the low-bandwidth chirp 224 comprising a bandwidth lesser than about 5 GHz, the high-bandwidth chirp 222 comprising a bandwidth greater than about 4 GHz with the low-bandwidth chirp 224 comprising a bandwidth lesser than about 4 GHz, the high-bandwidth chirp 222 comprising a bandwidth greater than about 3 GHz with the low-bandwidth chirp 224 comprising a bandwidth lesser than about 3 GHz, and/or other configurations. In some instances, both the high-bandwidth chirp 222 and the low-bandwidth chirp 224 have bandwidths greater than about 7 GHz, or both the high-bandwidth chirp 222 and the low-bandwidth chirp 224 have bandwidths lesser than about 3 GHz (with the high-bandwidth chirp 222 continuing to have a greater bandwidth than the low-bandwidth chirp 224). In some implementations, the high-bandwidth chirp 222 has a bandwidth greater than about 7 GHz, and the low-bandwidth chirp 224 has a bandwidth lesser than about 3 GHz.

FIG. 2A conceptually depicts the radar system 206 of the HMD 202 emitting a multi-chirp FMCW radar signal (e.g., corresponding to the signal shown in graph 212). In particular, FIG. 2A conceptually depicts the radar system 206 of the HMD 202 emitting the high-bandwidth chirp 222 (e.g., high-bandwidth chirp 222A propagating away from the HMD 202). Similarly, FIG. 2A conceptually depicts the radar system 206 of the HMD 202 emitting the low-bandwidth chirp 224 (e.g., low-bandwidth chirp 224A propagating away from the HMD 202).

As indicated above, the radar system 206 may utilize the transmitter 208 to emit the multi-chirp FMCW radar signal. In some instances, each transmitter 208 of the radar system 206 is individually configured to emit a multi-chirp FMCW radar signal. In this regard, each individual radar transmitter 208 of a radar system 206 (or of an HMD 202) may be individually configured to emit both a high-bandwidth chirp 222 and a low-bandwidth chirp 224 of a multi-chirp FMCW radar signal (e.g., in contrast with existing systems that use multiple radar bandwidths, where each transmitter is configured to emit a single, respective bandwidth). In some instances, the transmitter 208 of a radar system 206 is configured to emit the multi-chirp FMCW radar signal at the firmware level (which may contribute to power-efficient operation of the transmitter).

As noted above, some regulatory entities impose regulations that constrain transmission power for high-bandwidth FMCW radar signals. In this regard, to comply with regulations, the high-bandwidth chirp 222 may be emitted by the transmitter 208 with a lower transmission power than the low-bandwidth chirp 224 during interleaved transmission of the high-bandwidth chirp 222 and the low-bandwidth chirp 224. Although the reduced transmission power for the high-bandwidth chirp 222 reduces its sensor range, the high-bandwidth chirp 222 may still be usable to detect nearby objects with high precision (e.g., the elevated hand 260 of the user 204).

Some regulatory entities impose lesser constraints on transmission power for low-bandwidth FMCW radar signals. Thus, in some instances, the low-bandwidth chirp 224 may be emitted by the transmitter 208 with a higher transmission power than the high-bandwidth chirp 222. The relatively higher transmission power for the low-bandwidth chirp 224 can provide increased sensor range (e.g., relative to that of the high-bandwidth chirp 222), which can make the low-bandwidth chirp usable to detect more distant objects with sufficient precision (e.g., the foot 262 of the user 204).

In view of the foregoing, in some instances, the low-bandwidth FMCW radar signals (operating with relatively higher power) may be utilized to detect pose data for distant objects (e.g., positioned further than about one meter from the radar system), and the high-bandwidth FMCW radar signals may be utilized to detect pose data for nearer objects (e.g., positioned closer than about one meter from the radar system).

FIG. 2A conceptually depicts a reflected high-bandwidth chirp 226A propagating toward the HMD 202 and the radar system 206. The reflected high-bandwidth chirp 226A of FIG. 2A comprises a reflection of the high-bandwidth chirp 222A off of an object in the scene (e.g., off of the hand 260 of the user 204). Similarly, FIG. 2A conceptually depicts a reflected low-bandwidth chirp 228A propagating toward the HMD 202 and the radar system 206. The reflected low-bandwidth chirp 228A comprises a reflection of the low-bandwidth chirp 224A off of an object in the scene (e.g., off of the foot 262 of the user 204).

In the example of FIG. 2A, the reflected high-bandwidth chirp 226A and the reflected low-bandwidth chirp 228A are detected by the receiver 210 of the radar system 206. Graph 214 of FIG. 2A provides a simplified representation of aspects of reflected multi-chirp FMCW radar signals that the receiver 210 of the radar system 206 may be configured to detect. In particular, graph 214 depicts a reflected high-bandwidth chirp 226 (represented in FIG. 2A with half dash lines, see legend 220) and a reflected low-bandwidth chirp 228 (represented in FIG. 2A with dotted lines, see legend 220).

Graph 214 also depicts the high-bandwidth chirp 222 to illustrate the temporal offset between the emission of the high-bandwidth chirp 222 and the detection of the reflected high-bandwidth chirp 226. Similarly, graph 214 also depicts the low-bandwidth chirp 224 to illustrate the temporal offset between the emission of the low-bandwidth chirp 224 and the detection of the reflected low-bandwidth chirp 228. For ease of illustration and explanation, other transformations to the reflected chirps (e.g., relative to the emitted chirps) are omitted in FIG. 2A.

A system (e.g., the HMD 202 or radar system 206) may utilize the differences between the reflected chirps and the emitted chirps (e.g., temporal shifts, frequency shifts) of the multi-chirp FMCW radar signal to determine pose information for objects in the scene. FIG. 2B illustrates a conceptual representation of the receiver 210 having detected the reflected high-bandwidth chirp 226 and the reflected low-bandwidth chirp 228 (as indicated by the arrows extending from the receiver 210 toward the reflected high-bandwidth chirp 226 and the reflected low-bandwidth chirp 228).

The radar system 206 (or the HMD 202) may utilize signal characteristics of the reflected high-bandwidth chirp 226 (and signal characteristics of the high-bandwidth chirp 222 that was initially emitted) to determine first object pose data 230 (e.g., using range doppler and/or other radar positioning and/or signal disambiguation techniques). The first object pose data 230 indicates position and/or motion attributes for one or more objects in the scene that the reflected high-bandwidth chirp 226 reflected off of. In the example of FIGS. 2A and 2B, the reflected high-bandwidth chirp 226 reflects off of the hand 260 of the user 204. Thus, in the example of FIG. 2B, the first object pose data 230 represents position and/or motion attributes of the hand 260 of the user 204.

Similarly, radar system 206 (or the HMD 202) may utilize signal characteristics of the reflected low-bandwidth chirp 228 (and signal characteristics of the low-bandwidth chirp 224 that was initially emitted) to determine second object pose data 232, indicating position and/or motion attributes for objects in the scene that the reflected low-bandwidth chirp 228 reflected off of. In the example of FIGS. 2A and 2B, the reflected low-bandwidth chirp 228 reflects off of the foot 262 of the user 204. Thus, in the example of FIG. 2B, the second object pose data 232 represents position and/or motion attributes of the foot 262 of the user 204.

Although the first object pose data 230 and the second object pose data 232 are associated with particular objects in the example of FIG. 2B, one will appreciate that components of a reflected multi-chirp FMCW radar signal (e.g., the reflected high-bandwidth chirp 226 and the reflected low-bandwidth chirp 228) may be utilized to detect pose data for any type and/or number of objects. For instance, the first object pose data 230 may indicate position and/or motion attributes of the shoulders or elbows of the user 204 (and/or of environment objects such as walls). As another example, the second object pose data 232 may indicate position and/or motion attributes of the legs or knees of the user 204 (and/or of environment objects such as floors). Furthermore, as noted above, the principles discussed herein may be applied on other types of devices aside from HMDs. For instance, a radar system employing multi-chirp FMCW radar signals may be implemented on an autonomous vehicle to enable multi-range object detection, such that the vehicle's radar system is able to resolve mid-range objects with high resolution and very far targets with lower resolution (within the same operational frames).

In some implementations, the pose data obtained using the radar system 206 (e.g., the first object pose data 230 and/or the second object pose data 232) may be used in combination with additional pose data obtained by an overarching system (e.g., the HMD 202). FIG. 2B depicts additional pose data 236 that may be obtained from one or more other sensor(s) 110 of the HMD 202. For instance, the HMD 202 may include image-based pose detection systems (e.g., cameras and/or processing modules for performing simultaneous localization and mapping (SLAM), eye tracking, hand tracking, etc.) as indicated in FIG. 2B by the dashed line extending from the HMD 202 toward the additional pose data 236. As another example, the HMD 202 may be associated with one or more inertial tracking systems (inertial measurement units (IMUs)), which may be positioned on the HMD 202 and/or on peripheral devices (e.g., on a controller 234). Such inertial tracking systems may additionally or alternatively give rise to additional pose data 236 (as indicated in FIG. 2B by the dashed line extending from the controller 234 to the additional pose data 236).

FIG. 2B furthermore illustrates an example in which the additional pose data 236 is fused with the first object pose data 230 and/or the second object pose data 232 via a fuser 240 to obtain a composite pose 242. For example, the pose 242 may comprise a full-body pose for the user 204, with different aspects of the full-body pose being based upon pose data contributions from different sensors. The fuser 240 may comprise one or more jointly optimized AI modules trained on multiple types of input pose data (e.g., radar-based pose data, image-based pose data, IMU-based pose data) with ground truth of true poses.

As noted above, a radar system 206 may be configured for power-efficient operation while emitting and/or detecting a multi-chirp FMCW signal. In some examples, a transmitter 208 of a radar system 206 consumes less than 10 milliwatts to emit a multi-chirp FMCW radar signal (or less than 5 milliwatts). In some instances, a radar system that emits a multi-chirp FMCW radar signal consumes more than 10 milliwatts (e.g., for higher transmission power applications with lesser regulatory constraints, such as on autonomous vehicles).

In some implementations, other tracking systems of an HMD 202 (or other overarching system on which a radar system 206 is implemented) consume more power than the radar system 206. For example, in MR HMDs, hand tracking sensors and/or processing modules can consume hundreds of milliwatts of power while functioning (e.g., to power image sensors, illuminators, object segmentation and/or other modules, etc.). Thus, in some instances, pose data obtained via a radar system 206 may be utilized to facilitate selective activation of other tracking systems and/or components. Such functionality can enable power savings for HMDs and/or other systems, while still maintaining tracking functionality at critical times to provide desirable user experiences.

FIG. 2C illustrates a conceptual representation of selectively activating an additional tracking system based on the pose information obtained via radar system 206 of the HMD 202. In particular, in the example of FIG. 2C, the HMD 202 determines whether the first object pose data 230 for an object satisfy one or more conditions (indicated in FIG. 2C by decision block 250). In response to determining that the first object pose data 230 satisfying the condition(s), the HMD 202 may selectively activate an object tracking system (indicated in FIG. 2C by action block 252, with the “Yes” arrow extending from decision block 250 to action block 252).

Upon activation, the object tracking system may obtain tracking data to facilitate positional tracking for the object associated with the first object pose data 230. For instance, in one example, the object tracking system may comprise sensors and/or processing modules of the HMD 202 for performing hand tracking (e.g., a hand tracking system). The first object pose data 230 may indicate position and/or motion characteristics of the hand 260 of the user 204. The condition(s) associated with decision block 250 may include the position of the hand 260 of the user 204 being within the range of perception of the hand tracking system (e.g., within a field of view of image sensors of the hand tracking system). Additional or alternative conditions for selectively activating the hand tracking system may include the position of the hand 260 of the user 204 being within proximity to the range of perception of the hand tracking system (e.g., within about one foot (or more or less) of the field of view of the image sensors of the hand tracking system), or the position of the hand 260 of the user 204 approaching the range of perception of the hand tracking system. Conditions (and/or others) may be combined and/or weighted as appropriate.

In some instances, the condition(s) associated with decision block 250 rely on information associated with other devices and/or sensor systems (e.g., an orientation of the HMD 202, a user gaze direction, a user field of view, inertial tracking data of the HMD or a controller being held by the hand 260, etc.).

In response to determining that the first object pose data 230 satisfying the conditions, the HMD 202 may selectively refrain from activating the object tracking system (indicated in FIG. 2C by action block 254, with the “No” arrow extending from decision block 250 to action block 254).

As noted above, power consumption associated with the radar system 206 may be less than power consumption associated with the hand (or other object) tracking system that can be selectively activated based on pose data obtained via the radar system 206. The selective activation of the hand tracking system using pose data obtained by the radar system 206 may thus facilitate power savings by enabling the hand tracking system to remain in an inactive state when not needed for user experiences (e.g., when the user's hands are not in view and therefore need not be tracked in a granular, fully articulated manner).

Although at least some examples discussed herein with reference to FIG. 2C have focused on selectively activating a hand tracking system, radar-based positioning data obtained using multi-chirp FMCW radar signals may be utilized to facilitate selective activation of other types of object tracking systems, in accordance with implementations of the present disclosure. Furthermore, although at least some examples discussed herein with reference to FIG. 2C have focused on using the first object pose data 230 to selectively activate an additional tracking system, reflected high-bandwidth chirp data may additionally or alternatively be utilized to facilitate selective activation of additional tracking systems.

### Example Method(s)

The following discussion now refers to a number of methods and method acts that may be performed in accordance with the present disclosure. Although the method acts are discussed in a certain order and illustrated in a flow chart as occurring in a particular order, no particular ordering is required unless specifically stated, or required because an act is dependent on another act being completed prior to the act being performed. One will appreciate that certain embodiments of the present disclosure may omit one or more of the acts described herein.

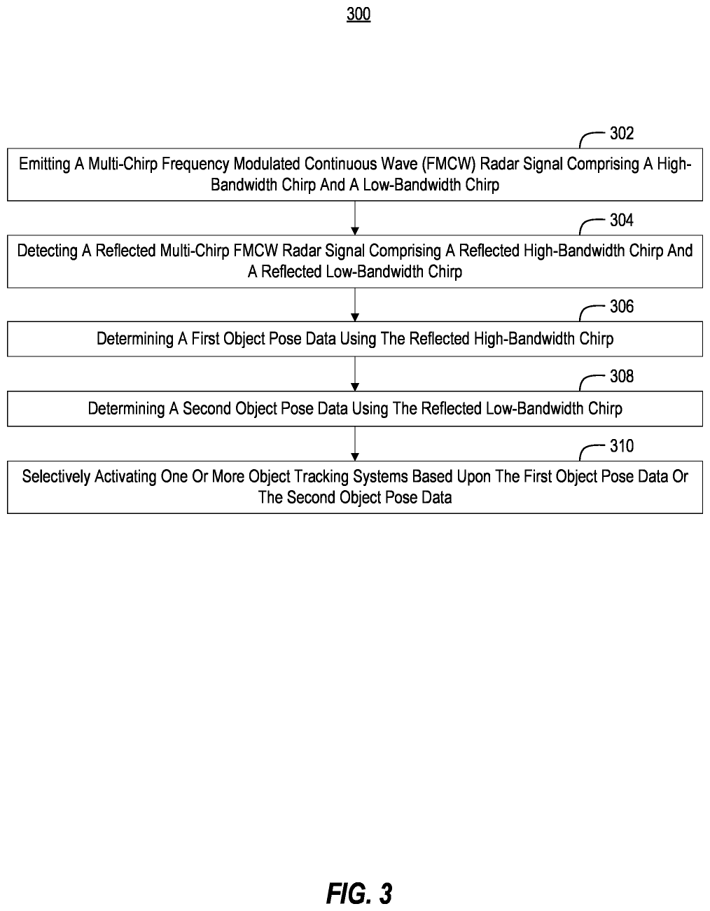

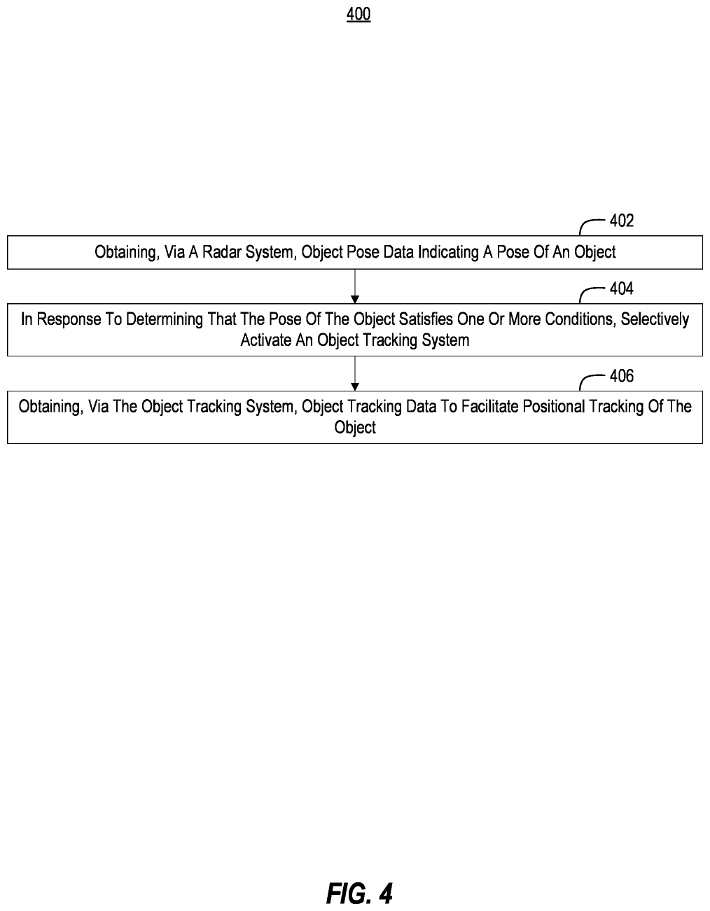

FIGS. 3 and 4 illustrate example flow diagrams 300 and 400, respectively, depicting acts associated with facilitating pose detection via multi-chirp FMCW radar. The acts of flow diagrams 300 and 400 may be performed utilizing one or more components of one or more systems (e.g., system 100, HMD 202, radar system 206, etc.).

Act 302 of flow diagram 300 of FIG. 3 includes emitting a multi-chirp frequency modulated continuous wave (FMCW) radar signal comprising a high-bandwidth chirp and a low-bandwidth chirp. In some implementations, the high-bandwidth chirp and the low-bandwidth chirp are interleaved to form the multi-chirp FMCW radar signal. In some instances, the low-bandwidth chirp comprises a higher transmission power than the high-bandwidth chirp. In some implementations, the high-bandwidth chirp comprises a bandwidth of about 6.8 GHz, and/or the low-bandwidth chirp comprises a bandwidth of about 3.4 GHz.

In some examples, the multi-chirp FMCW radar signal is emitted by a single radar transmitter. A radio transmitter that performs act 302 may be associated with firmware instructions configured to cause the radar transmitter to emit the multi-chirp FMCW radar signal.

In some instances, the radar transmitter consumes less than 10 milliwatts to emit the multi-chirp FMCW radar signal (or less than 5 milliwatts).

Act 304 of flow diagram 300 includes detecting a reflected multi-chirp FMCW radar signal comprising a reflected high-bandwidth chirp and a reflected low-bandwidth chirp.

Act 306 of flow diagram 300 includes determining a first object pose data using the reflected high-bandwidth chirp. Act 308 of flow diagram 300 includes determining a second object pose data using the reflected low-bandwidth chirp. In some instances, the first object pose data and/or the second object pose data are obtained using range doppler techniques.

Act 310 of flow diagram 300 includes selectively activating one or more object tracking systems based upon the first object pose data or the second object pose data. In some instances, the one or more object tracking systems are associated with a head-mounted display connected to a radar system that performs one or more of acts 302-308.

A head-mounted display (HMD) connected to a radar system that performs one or more of acts 302-308 can be configured for operation by a user. In some instances, the first object pose data of act 306 comprises object pose data associated with one or more shoulders, elbows, or hands of the user. In some instances, the second object pose data of act 308 comprises object pose data associated with one or more legs or feet of a user. In some instances, the HMD fuses the first object pose data of act 306, the second object pose data of act 308, and additional pose data to obtain a pose of the user. The additional pose data may be obtained using one or more image-based pose detection systems associated with the HMD. In some instances, the additional pose data is obtained using one or more inertial tracking systems associated with the HMD.

Act 402 of flow diagram 400 of FIG. 4 includes obtaining, via a radar system, object pose data indicating a pose of an object. In some implementations, the radar system is configured to emit a multi-chirp frequency modulated continuous wave (FMCW) radar signal comprising a high-bandwidth chirp and a low-bandwidth chirp to obtain the object pose data.

Act 404 of flow diagram 400 includes, in response to determining that the pose of the object satisfies one or more conditions, selectively activate an object tracking system. In some instances, the one or more conditions comprise the pose of the object being within, in proximity to, or approaching a range of perception of the object tracking system. In some implementations, the radar system comprises a lower power consumption than the object tracking system.

Act 406 of flow diagram 400 includes obtaining, via the object tracking system, object tracking data to facilitate positional tracking of the object.

### Additional Details Related to the Disclosed Embodiments

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

As used herein, the term “about”, when used to modify a numerical value or range, refers to any value within 5%, 10%, 15%, 20%, or 25% of the numerical value modified by the term “about”.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope

We claim:

1. A radar system for object pose detection, the radar system comprising:
one or more processors; and
one or more hardware storage devices that store instructions that are executable by the one or more processors to configure the radar system to:
emit a multi-chirp frequency modulated continuous wave (FMCW) radar signal comprising a high-bandwidth chirp and a low-bandwidth chirp;
detect a reflected multi-chirp FMCW radar signal comprising a reflected high-bandwidth chirp and a reflected low-bandwidth chirp;
determine a first object pose data using the reflected high-bandwidth chirp; and
determine a second object pose data using the reflected low-bandwidth chirp.

2. The radar system of claim 1, wherein the high-bandwidth chirp and the low-bandwidth chirp are interleaved to form the multi-chirp FMCW radar signal.

3. The radar system of claim 1, wherein the multi-chirp FMCW radar signal is emitted by a single radar transmitter.

4. The radar system of claim 1, further comprising a radar transmitter, wherein the instructions comprise firmware instructions configured to cause the radar transmitter to emit the multi-chirp FMCW radar signal.

5. The radar system of claim 4, wherein the radar transmitter consumes less than 10 milliwatts to emit the multi-chirp FMCW radar signal.

6. The radar system of claim 5, wherein the radar transmitter consumes less than 5 milliwatts to emit the multi-chirp FMCW radar signal.

7. The radar system of claim 1, wherein the low-bandwidth chirp comprises a higher transmission power than the high-bandwidth chirp.

8. The radar system of claim 1, wherein the high-bandwidth chirp comprises a bandwidth of about 6.8 GHz, and wherein the low-bandwidth chirp comprises a bandwidth of about 3.4 GHz.

9. The radar system of claim 1, wherein the radar system is connected to a head mounted display (HMD) configured for operation by a user.

10. The radar system of claim 9, wherein the first object pose data comprises object pose data associated with one or more shoulders, elbows, or hands of the user.

11. The radar system of claim 9, wherein the second object pose data comprises object pose data associated with one or more legs or feet of a user.

12. The radar system of claim 9, wherein the instructions are executable by the one or more processors to configure the radar system or the HMD to fuse the first object pose data, the second object pose data, and additional pose data to obtain a pose of the user.

13. The radar system of claim 12, wherein the additional pose data is obtained using one or more image-based pose detection systems associated with the HMD.

14. The radar system of claim 12, wherein the additional pose data is obtained using one or more inertial tracking systems associated with the HMD.

15. The radar system of claim 1, wherein the instructions are executable by the one or more processors to configure the radar system to selectively activate one or more object tracking systems based upon the first object pose data or the second object pose data.

16. A system for object tracking, comprising:
one or more processors; and
one or more hardware storage devices that store instructions that are executable by the one or more processors to configure the system to:
obtain, via a radar system, object pose data indicating a pose of an object;
in response to determining that the pose of the object satisfies one or more conditions, selectively activate an object tracking system; and
obtain, via the object tracking system, object tracking data to facilitate positional tracking of the object.

17. The system of claim 16, wherein the one or more conditions comprise the pose of the object being within, in proximity to, or approaching a range of perception of the object tracking system.

18. The system of claim 16, wherein the radar system is configured to emit a multi-chirp frequency modulated continuous wave (FMCW) radar signal comprising a high-bandwidth chirp and a low-bandwidth chirp to obtain the object pose data.

19. The system of claim 16, wherein the radar system comprises a lower power consumption than the object tracking system.

20. A head mounted display (HMD), comprising:
a radar system configured to emit a multi-chirp frequency modulated continuous wave (FMCW) radar signal comprising a high-bandwidth chirp and a low-bandwidth chirp.
